(19) United States
(12) Patent Application Publication
(10) Pub. No.: US 2013/0322946 A1
(43) Pub. Date: Dec. 5, 2013

(54) PRINTING APPARATUS FOR USE WITH SHEET PROCESSING APPARATUS, CONTROL METHOD AND STORAGE MEDIUM THEREFOR, AND PRINTING SYSTEM

(71) Applicant: CANON KABUSHIKI KAISHA, Tokyo (JP)

(72) Inventor: Hideyuki Okada, Kawasaki-shi (JP)

(73) Assignee: CANON KABUSHIKI KAISHA, Tokyo (JP)

(21) Appl. No.: 13/869,209

(22) Filed: Apr. 24, 2013

(30) Foreign Application Priority Data
Jun. 4, 2012 (JP) 2012-127007

(51) Int. Cl. B41J 13/00

(52) U.S. Cl. CPC B41J 13/0036
USPC 400/582

(57) ABSTRACT

A printing apparatus that enables printed products to be removed from a sheet processing apparatus at scheduled time. The printing apparatus is configured to discharge printed products to a stacking tray that is provided in the sheet processing apparatus so as to be movable upward and downward. The printing apparatus accepts a setting of scheduled time at which printed products are to be taken out of the stacking tray, and causes the stacking tray to move downward to a removal position when the setting time is reached.

### BACKGROUND OF THE INVENTION

1. Field of the Invention

The present invention relates to a printing apparatus for use with a sheet processing apparatus such as a stacker capable of stacking a large volume of printed products, a control method for the printing apparatus, a storage medium storing a program for executing the control method, and a printing system including the printing apparatus and the sheet processing apparatus.

2. Description of the Related Art

A printing apparatus is sometimes used with a sheet processing apparatus such as a stacker that receives printed products (printed sheets) discharged from the printing apparatus or a finisher that staples a bundle of sheets. For example, a production printer for high-volume printing is known which is used with a large-capacity stacker capable of receiving a large volume of printed products.

The large-capacity stacker can be configured that a large volume of printed products can be collectively taken out therefrom. Such stacker has, e.g., a stacking tray on which printed products can be stacked and a cart on which the stacking tray can be placed. The cart is configured to be capable of being transported to the outside of the stacker, with the stacking tray placed on the cart. The stacking tray is configured to be movable upward and downward inside the stacker according to stack of printed products. Specifically, the stacking tray is moved upward to a predetermined position at start of stacking of printed products and gradually moved downward with the progress of stacking of printed products. When receiving a command for removal of printed products, the stacker causes the stacking tray to move to a removal position and to be placed on the cart. An operator can transport the cart on which the stacking tray stacked with printed products is placed to the outside of the stacker.

However, when the operator attempts to remove the printed products stacked on the stacking tray after completion of the print job, it becomes impossible to immediately remove the printed products, if a subsequent job is started to discharge other printed products.

To obviate this, there has been proposed a method in which a reservation for removal of printed products can selectively be set for each job, and upon completion of printing of a job for which the reservation has been set, a subsequent job is set in a print wait state (see, for example, Japanese Laid-open Patent Publication No. 2007-219495).

However, in a case that the removal of printed products is controlled on a per job basis in this manner, printed products cannot sometimes be removed at scheduled time.

### SUMMARY OF THE INVENTION

The present invention provides a printing apparatus that enables printed products to be removed from a sheet processing apparatus at scheduled time, a control method therefor, a storage medium storing a program for executing the control method, and a printing system including the printing apparatus.

According to one aspect of this invention, there is provided a printing apparatus for discharging printed products to a stacking tray which is movably provided in a sheet processing apparatus and on which the printed products can be stacked, which comprises an acceptance unit configured to accept a setting of a removal time representing time at which printed products are to be taken out of the stacking tray, and a control unit configured to control, based on the setting of the removal time, to move the stacking tray to a removal position.

With this invention, it is possible to remove printed products at scheduled time from the sheet processing apparatus such as a stacker.

Further features of the present invention will become apparent from the following description of an exemplary embodiment with reference to the attached drawings.

### BRIEF DESCRIPTION OF THE DRAWINGS

FIG. 1 is a view showing an example of a network environment of a printing system that includes a printing apparatus according to one embodiment of this invention;

FIG. 2 is a block diagram showing a functional construction of the printing system;

FIG. 3 is an external view showing an operation unit of the printing apparatus;

FIG. 4 is a view schematically showing the construction of a sheet processing apparatus that is connected to the printing apparatus;

FIG. 5 is a flowchart showing procedures of a stacking tray descending process that is executed by the printing apparatus;

FIGS. 6A to 6C are views showing an example of a setting screen for reservation of descent of tray;

FIGS. 6D and 6E are views showing an example of a screen for notification of scheduled job completion time;

FIG. 7 is a view showing an example of a preference setting screen for reservation of descent of tray;

FIG. 8 is a flowchart showing procedures of a discharge stop process that is executed in the stacking tray descending process of FIG. 5;

FIG. 9 is a flowchart showing apart of procedures of the stacking tray descending process that is performed when preference settings of reservation of descent of tray have been made to give a priority to designated time; and

FIG. 10 is a view showing an example of a job management screen that is displayed on the operation unit.

### DESCRIPTION OF THE EMBODIMENTS

The present invention will now be described in detail below with reference to the drawings showing a preferred embodiment thereof.

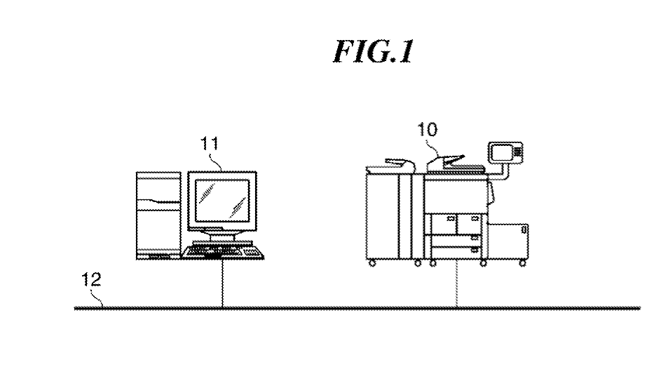

FIG. 1 shows an example of a network environment of a printing system that includes a printing apparatus according to one embodiment of this invention.

In FIG. 1, reference numeral 10 denotes a printing system that is connected to a PC 11 via a network 12. The PC 11 transmits PDL (page description language) code data to the printing system 10 via the network 12.

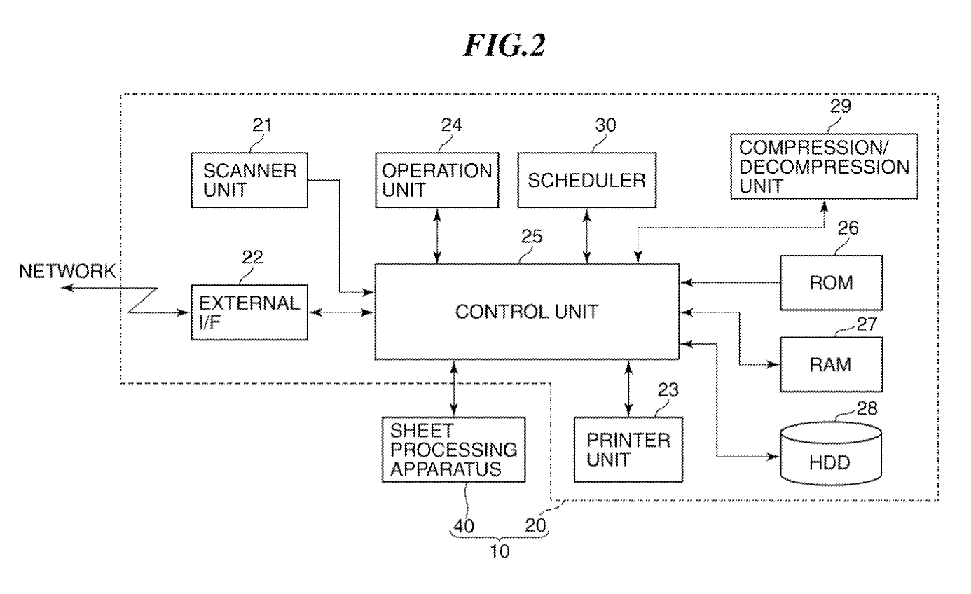

FIG. 2 shows in block diagram a functional structure of the printing system 10.

The printing system 10 includes a printing apparatus 20 implemented by a multi-function peripheral having plural functions such as copy and printer functions or implemented by a single-function peripheral only having a copy or printer function, and also includes a sheet processing apparatus 40 connected to the printing apparatus 20. The sheet processing apparatus 40 is configured to be capable of communicating with the printing apparatus 20 and executing sheet processing according to an instruction supplied from the printing apparatus 20. In this embodiment, the sheet processing apparatus 40 is comprised of a stacker capable of receiving a large volume of printed products.

The printing apparatus 20 has a scanner unit 21 that reads an image of an original, converts the image into image data, and transmits the image data to a control unit 25. An external I/F 22 transmits and receives data to and from an external apparatus (e.g., PC 11) connected to the network 12. A printer unit 23 prints images on sheets based on image data read by the scanner unit 21 or image data input from the external apparatus.

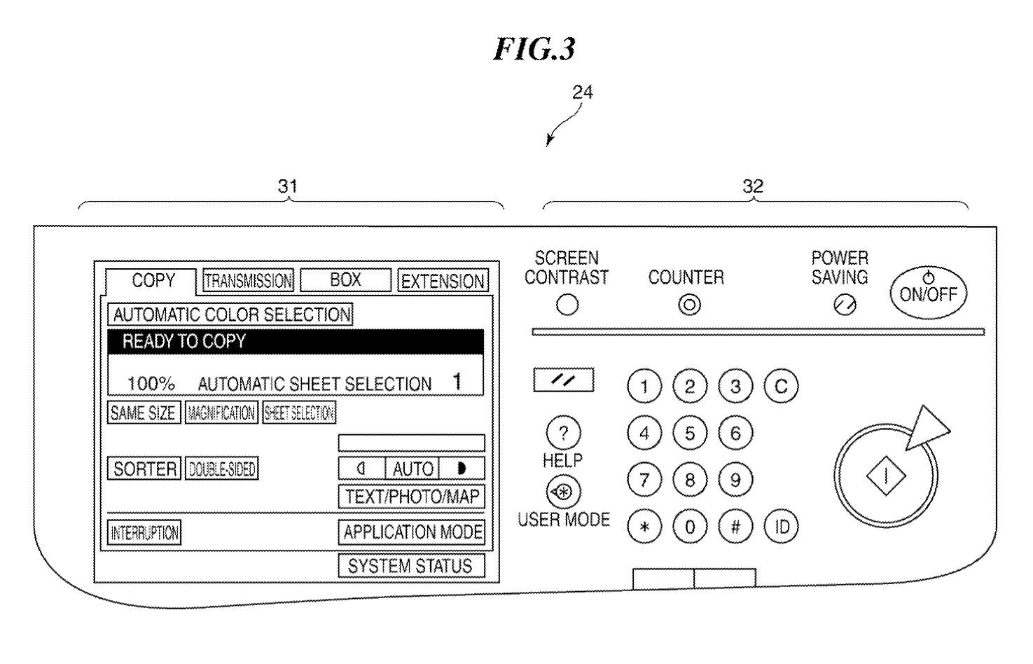

An operation unit 24 has a touch panel part 31 and a hardware key input part 32 which are shown in FIG. 3, accepts an operator's instruction via the parts 31, 32, and performs display on the touch panel part 31 where required.

The control unit 25 centrally controls various units of the printing system 10 such as the printing apparatus 20 and the sheet processing apparatus 40.

A ROM 26 stores computer programs for execution by the control unit 25. For example, the ROM 26 stores programs for executing below-described processes, programs for displaying below-described setting screens, and a program for developing PDL code data received from the PC 11 into raster image data. The ROM 26 also stores a boot sequence, font information, etc.

A RAM 27 stores image data supplied from the scanner unit 21, PDL code data supplied from the external I/F 22, and a program and setting information loaded from the ROM 26. The RAM 27 also stores information about the sheet processing apparatus 40 (e.g., information representing a maximum number of sheets that can be stacked on the stacker). The control unit 25 performs control by using data, etc. stored in the RAM 27.

A HDD (hard disk drive) 28 is a large-capacity storage device configured by, e.g., a hard disk and a drive unit for data writing and reading to and from the hard disk. The HDD 28 stores image data input from the scanner unit 21 and compressed by a compression/decompression unit 29, and also is used as a spooler.

The control unit 25 can transfer image data stored in the HDD 28 to the printer unit 23 according to an operator's instruction to cause the printer unit 23 to print the image data. The control unit 25 also can store PDL code data received from the PC 11 as a print job into the HDD 28. The control unit 25 can manage jobs such as print jobs stored in the HDD 28 and can acquire information representing the number of the stored jobs and information set for the jobs.

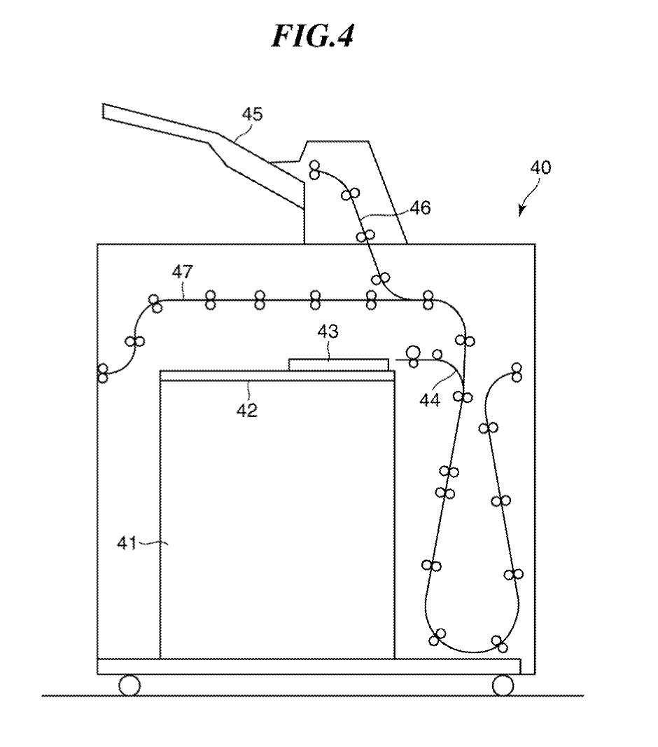

A scheduler 30 manages, in association with time, tasks such as starting of a job, displaying of a message on the touch panel part 31, turning on/off of power, and upward or downward movement of the stacking tray (denoted by reference numeral 42 in FIG. 4) in the sheet processing apparatus 40. When a predetermined time is reached, the scheduler 30 notifies the control unit 25 of a task associated with the predetermined time. The control unit 25 controls execution of the task notified from the scheduler 30.

By using a compression method such as JBIG or JPEG, the compression/decompression unit 29 compresses or decompresses e.g. image data stored in the RAM 27 or in the HDD 28.

The touch panel part 31 and hardware key input part 32 of the operation unit 24 are a user interface that functions as an acceptance unit for accepting an operator's instruction. Soft keys, hard keys, and a user interface screen of the operation unit 24 shown in FIG. 3 are a mere example and accordingly the acceptance unit is not limited thereto. For example, a user interface provided by an external apparatus (such as the PC 11) capable of transmitting a request for job execution to the printing system 10 can be used as the acceptance unit that accepts an operator's instruction.

Next, with reference to FIG. 4, a description will be given of the sheet processing apparatus 40. FIG. 4 schematically shows the construction of the sheet processing apparatus 40.

The sheet processing apparatus 40 of this embodiment is configured as a stacker. More specifically, the sheet processing apparatus 40 has a stacking unit 41 that stores printed sheets (printed products) and a stacking tray 42 which is provided in the stacking unit 41 so as to be movable upward and downward and on which printed products are stacked. Reference numeral 43 denotes a bundle of printed products. The stacking tray 42 is capable of stacking e.g. 5000 sheets of printed products and is gradually moved downward with the progress of stacking of printed products on the stacking tray 42 that are conveyed from the printing apparatus 20 via a stack path 44.

The sheet processing apparatus 40 also has a sample tray 45. Although printed products that are being discharged to the stacking tray 42 cannot be confirmed in hand, the status of printing can be confirmed in hand by outputting copies of printed products to the sample tray 45. In that case, printed products conveyed from the printing apparatus 20 are discharged to the sample tray 45 via a sample tray discharge path 46. In a case where printed products cannot be stacked on the stacking unit 41 for any reason or in a case where a jam has occurred, the sample tray 45 is used as an escape tray to which printed product are discharged.

The sheet processing apparatus 40 is configured to be capable of conveying printed products to the downstream side. In a case where a post-processing apparatus (not shown) such as a finisher is disposed downstream of the sheet processing apparatus 40, the sheet processing apparatus 40 conveys printed products, which are supplied from the printing apparatus 20, to the post-processing apparatus via a straight path 47.

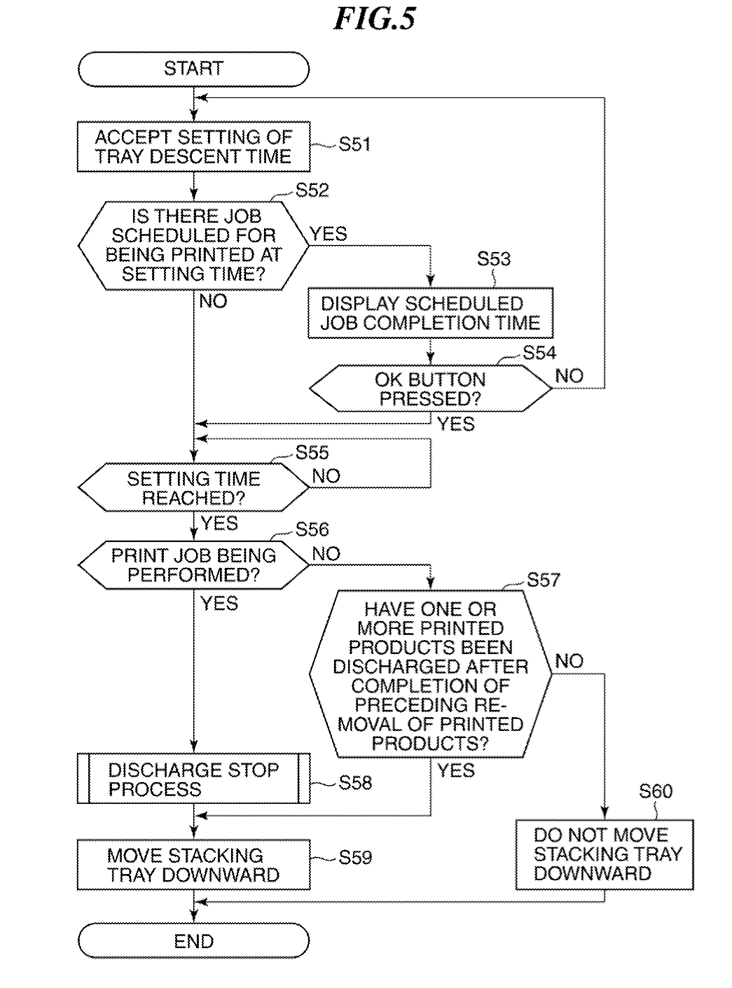

FIG. 5 shows in flowchart the procedures of a stacking tray descending process executed by the printing apparatus 20. It should be noted that this process is executed by the control unit 25 of the printing apparatus 20 by executing a program stored in the ROM 26.

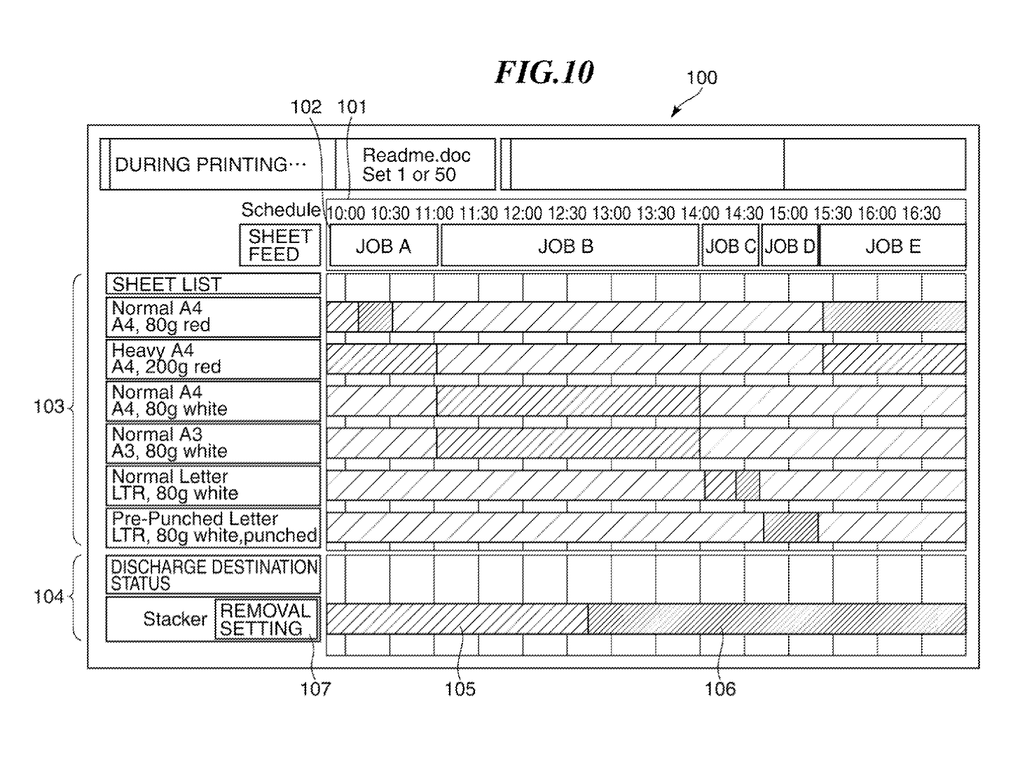

The control unit 25 first accepts a setting of a tray descent time (step S51). The tray descent time is set by an operator through e.g. a job management screen 100 shown in FIG. 10 and displayed on the operation unit 24.

Referring to FIG. 10, the job management screen 100 has a time display field 101 in which time is displayed in units of 30 minutes, a job display field 102 in which accepted jobs are displayed, and a sheet list/remaining amount display field 103 in which a list of sheet types used for jobs and a remaining sheet amount display bar are displayed, whereby the operator can confirm what job will be printed at what time on what type of sheet.

The job management screen 100 also has a discharge destination status display field 104 in which a discharge destination, a discharge destination status display bar, and a removal setting button 107 are displayed. In this embodiment, printed products are discharged from the printing apparatus 20 to the stacker serving as the sheet processing apparatus 40. Accordingly, in the discharge destination status display field 104, an indication “stacker” is displayed as the discharge destination and bars 105, 106 are displayed as discharge destination status display bars representing the status of stacking of printed products on the stacking tray 42. The bar 105 represents a state where further printed products can be stacked on the stacking tray 42. The bar 106 represents a fully stacked state where an upper limit stacking amount is reached so that no further printed products can be stacked on the stacking tray 42. As a result, the operator can know when the stacking tray 42 of the stacker will be fully stacked with printed products.

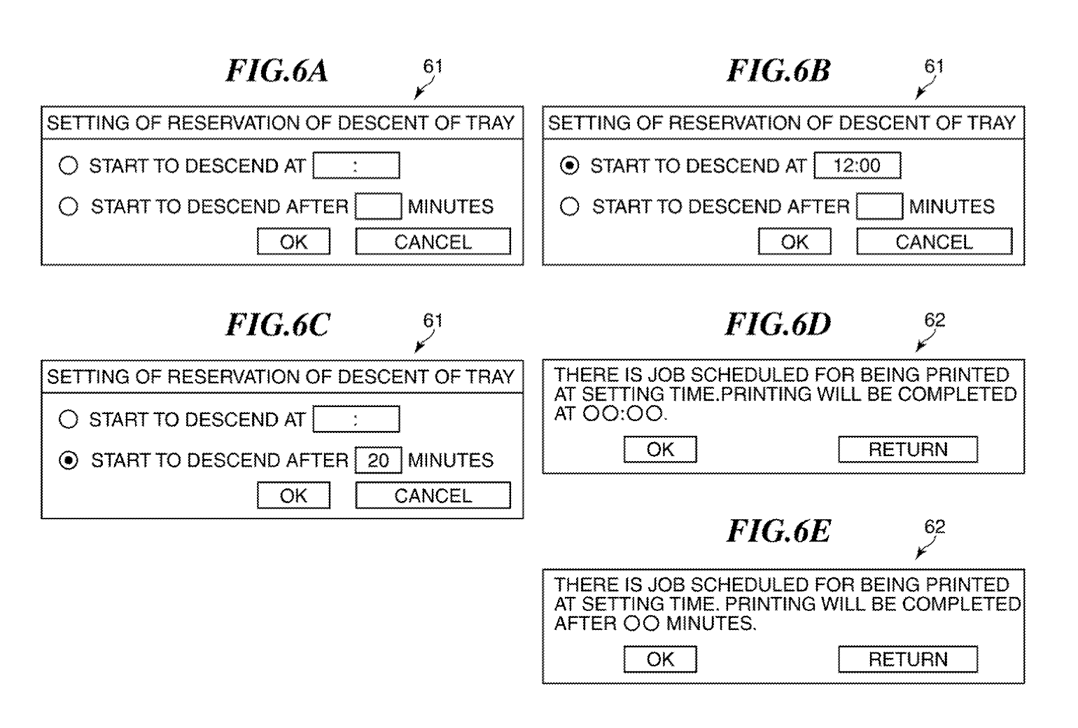

When the removal setting button 107 in the discharge destination status display field 104 is pressed (or selected) by the operator, the control unit 25 causes the operation unit 24 to display a setting screen 61 for reservation of descent of tray, which is shown in FIG. 6A, and accepts a setting of a tray descent time (at which the tray starts to descend in the illustrated example) set by the operator through the setting screen 61. The tray descent time is set in absolute time as shown in FIG. 6B (12:00 in the illustrated example) or in elapsed time from the current time as shown in FIG. 6C (after 20 minutes from the current time in the illustrated example). It should be noted that the method for setting the tray descent time (at which the tray starts or finishes to descend) is not limited to these methods. For example, the tray descent time can be set in relative time (relative to a reference time). By setting the tray descent time, it is possible to set a removal time representing time at which printed products are to be taken out of the stacking tray (more specifically, a scheduled time at which printed products are to be removed or a scheduled time at which the stacking tray is to be moved to a removal position).

Referring to FIG. 5 again, in step S52, the control unit 25 determines whether or not there is a job scheduled for being printed at the tray descent time set by the operator on the setting screen 61 for reservation of descent of tray. If determined that there is no job scheduled for being printed at the tray descent time (NO to step S52), the process proceeds to step S55. On the other hand, if determined that there is a job scheduled for being printed at the tray descent time (YES to step S52), the control unit 25 calculates a scheduled job completion time and causes a notification screen 62 shown in FIG. 6D or 6E to display the scheduled job completion time (step S53).

More specifically, in a case where the tray descent time has been set in absolute time by the operator on the setting screen 61 as shown in FIG. 6B, the control unit 25 calculates the scheduled job completion time in absolute time and causes the notification screen 62 to display the scheduled job completion time as shown in FIG. 6D. On the other hand, in a case where the tray descent time has been set in elapsed time from the current time as shown in FIG. 6C, the control unit 25 calculates the scheduled job completion time in elapsed time from the current time and causes the notification screen 62 to display, as shown in FIG. 6E, in how many minutes from now the job is scheduled to be finished.

As described above, in a case that there is a job scheduled for being printed at the tray descent time set by the operator, the tray descent time is notified to the operator. The operator confirms the content of the notification, and modifies, where required, the tray descent time previously set. Accordingly, interactive exchange can be established between the operator and the printing apparatus 20, and operation can be performed more efficiently.

If the OK button is pressed on the screen 62 for notification of scheduled job completion time (YES to step S54), the process proceeds to step S55 where the control unit 25 registers the tray descent time set by the operator into the scheduler 30 and waits until the tray descent time (setting time) is reached. When the setting time is reached (YES to step S55), the scheduler 30 notifies the control unit 25 to that effect. In response to the notification from the scheduler 30, the control unit 25 determines whether or not a print job is being performed to discharge printed products to the stacking tray 42 (step S56).

In other words, the control unit 25 functions as a determination unit that determines whether or not a print job to discharge printed products to the stacking tray is being performed when the removal time is reached.

If determined that a print job for discharging printed products to the stacking tray 42 is not being performed when the tray descent time is reached (NO to step S56), the control unit 25 determines whether or not one or more printed products have been discharged to the stacking tray 42 after completion of the preceding removal of printed products from the stacking tray (step S57). If determined that one or more printed products have been discharged (YES to step S57), the control unit 25 controls to move the stacking tray 42 downward (step S59). On the other hand, if determined that no printed product has been discharged (NO to step S57), the control unit 25 does not cause the stacking tray 42 to move downward (step S60), and completes the present process. In this manner, the control unit 25 causes the stacking tray 42 to move downward according to discharging and stacking of printed products to the stacking tray 42.

If determined that a print job for discharging printed products to the stacking tray 42 is being performed when the tray descent time is reached (YES to step S56), the control unit 25 performs a discharge stop process for temporarily stopping the discharge of printed documents to the stacking tray 42 (step S58), and causes the stacking tray 42 to move downward to the removal position (step S59). It should be noted that when determining in step S56 that a print job is being performed when the tray descent time is reached, the control unit 25 can notify the user that there is a job that is being printed.

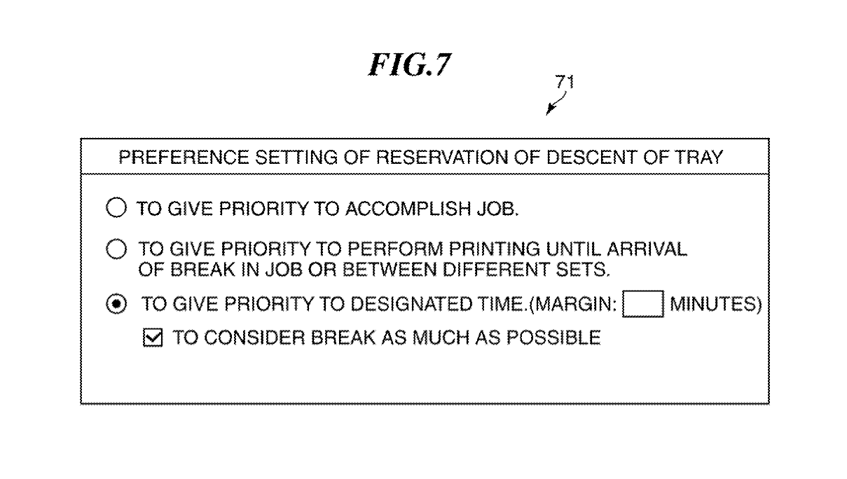

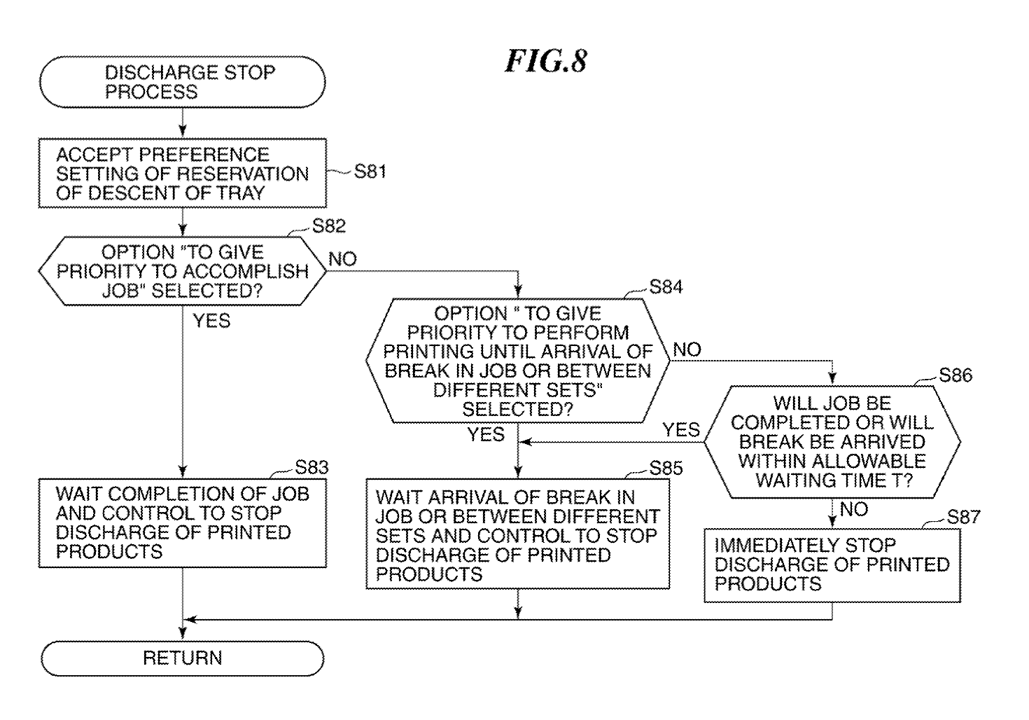

Next, with reference to FIGS. 7 and 8, a description will be given of the discharge stop process, which is executed in the stacking tray descending process of FIG. 5.

In this embodiment, if a job for discharging printed products to the sheet processing apparatus is being performed when the tray descent time set by the user is reached, the user can select to continue performing the job in execution in preference to causing the stacking tray 42 to move downward to the removal position at the tray descent time. Alternatively, the user can select to perform the job in execution until its completion or until arrival of a break in the job or a break between different sets of printed products (in the case of a job for outputting plural sets of printed products) in preference to causing the stacking tray 42 to move downward at the tray descent time. Alternatively, the user can select to cause the stacking tray to move downward at the tray descent time in preference to continuing the job which is in execution. At this time, in a case where the job in execution will be finished in a short time period from the current time or a break in the job or a break between different sets of printed products will be arrived in a short time period, the operator can select to perform the job in execution until its completion or until arrival of a break in the job or a break between different sets of printed products, or can designate that a break in the job or between different sets of printed products must be taken into consideration as much as possible.

To this end, the control unit 25 causes the operation unit 24 to display e.g. a preference setting screen for reservation of descent of tray, which is denoted by reference numeral 71 in FIG. 7. On the preference setting screen 71, there are displayed a first option “to give priority to accomplish job” for performing the job in execution in preference to causing the stacking tray to move downward at the tray descent time, a second option “to give priority to perform printing until arrival of break in job or between different sets” for performing the job in execution until its completion or until arrival of a break in the job or a break between different sets of printed products in preference to causing the stacking tray to move downward at the tray descent time, and a third option “to give priority to designated time” for causing the stacking tray to move downward at the tray descent time in preference to performing the job in execution.

On the preference setting screen 71, there are displayed in accompaniment with the third option “to give priority to designated time,” a margin time setting field in which a time period (allowable waiting time) T for which the job in execution can be continuously executed is set in units of minute in a case where the job in execution will be finished in a short time period from the current time or a break in the job or a break between different sets of printed products will be arrived in a short time period, and an option “to consider break as much as possible” for causing a break in the job or a break between different sets of printed products to be taken into consideration as much as possible.

FIG. 8 shows in flowchart the procedures of the discharge stop process executed in step S58 of the stacking tray descending process shown in FIG. 5. It should be noted that this process is executed by the control unit 25 by executing a program stored in the ROM 26.

In the discharge stop process, the control unit 25 accepts a preference setting of reservation of descent of tray set in advance by the operator through the preference setting screen 71 of FIG. 7 (step S81), and determines whether or not the option “to give priority to accomplish job” has been selected by the operator in the preference setting of reservation of descent of tray (step S82).

If determined that the option “to give priority to accomplish job” has been selected in the preference setting of reservation of descent of tray (YES to step S82), the control unit 25 waits completion of the job which is being performed at the tray descent time, and then controls to stop discharge of printed products to the sheet processing apparatus 40 (step S83).

If determined that the option “to give priority to perform printing until arrival of break in job or between different sets” has been selected by the operator in the preference setting of reservation of descent of tray (YES to step S84), the process proceeds to step S85 where the control unit 25 waits completion of the job or arrival of a break in the job or between different sets of printed products, and then controls to stop discharge of printed products to the sheet processing apparatus 40.

If determined that the option “to give priority to perform printing until arrival of a break in job or between different sets” has not been selected in the preference setting of reservation of descent of tray (NO to step S84), i.e., if determined that the option “to give priority to designated time” has been selected, the process proceeds to step S86 where the control unit 25 determines whether or not an allowable waiting time T has been set in the preference setting of reservation of descent of tray, and if an allowable waiting time T has been set, the control unit 25 determines whether or not the job will be completed or a break in the job or between different sets of printed products will be arrived within the allowable waiting time T.

If determined that the job will be completed or a break in the job or between different sets of printed products will be arrived within the allowable waiting time T (YES to step S86), the control unit 25 waits completion of the job or arrival of a break in the job or between different sets of printed products, and then controls to stop discharge of the printed products to the sheet processing apparatus 40 (step S85).

On the other hand, if determined that neither the job will be completed nor a break in the job or between different sets of printed products will be arrived within the allowable waiting time T (NO to step S86), the control unit 25 controls to immediately stop discharge of printed products to the sheet processing apparatus 40 (step S87).

In the following, a description will be given of a specific example of the discharge stop process. It is assumed, for example, that the tray descent time has been set to “12:00,” the option “to give priority to designated time” has been selected, and the allowable waiting time T has been set to 5 minutes in the preference setting of reservation of descent of tray, and on the other hand, a job for discharging printed products to the sheet processing apparatus 40 is being performed when the tray descent time 12:00 is reached. In this specific example, if determined that the job will be completed until 12:05 or if determined that processing such as printing up to a break in the job or between different sets of printed products will be completed until 12:05, the control unit 25 waits completion of the job or completion of the processing and then controls to stop discharge of printed products to the sheet processing apparatus 40. On the other hand, if determined that the job will not be completed until 12:05 or that processing up to a break in the job or between different sets of printed products will not be completed until 12:05, the control unit 25 controls to immediately stop discharge of printed products to the sheet processing apparatus 40 at the time of 12:00. Accordingly, in the case of a job for performing printing that will be completed within the allowable waiting time T, the operator can wait completion of the job at the will of the operator, whereby user-friendliness and productivity can be improved.

As described above, the operator can select the option “to give priority to designated time” and also can set the allowable waiting time T and select the option “to consider break as much as possible” on the preference setting screen 71 for reservation of descent of tray. In that case, if a remaining time up to the tray descent time is less than the allowable waiting time T, the control unit 25 controls not to start a job for performing printing which will not be completed before the tray descent time or a job for performing printing up to a break in the job or between different sets of printed products which will not be completed before the tray descent time, thereby avoiding a situation that the designated time (tray descent time) is reached during the printing and hence discharge of printed products must be stopped in the process of the printing.

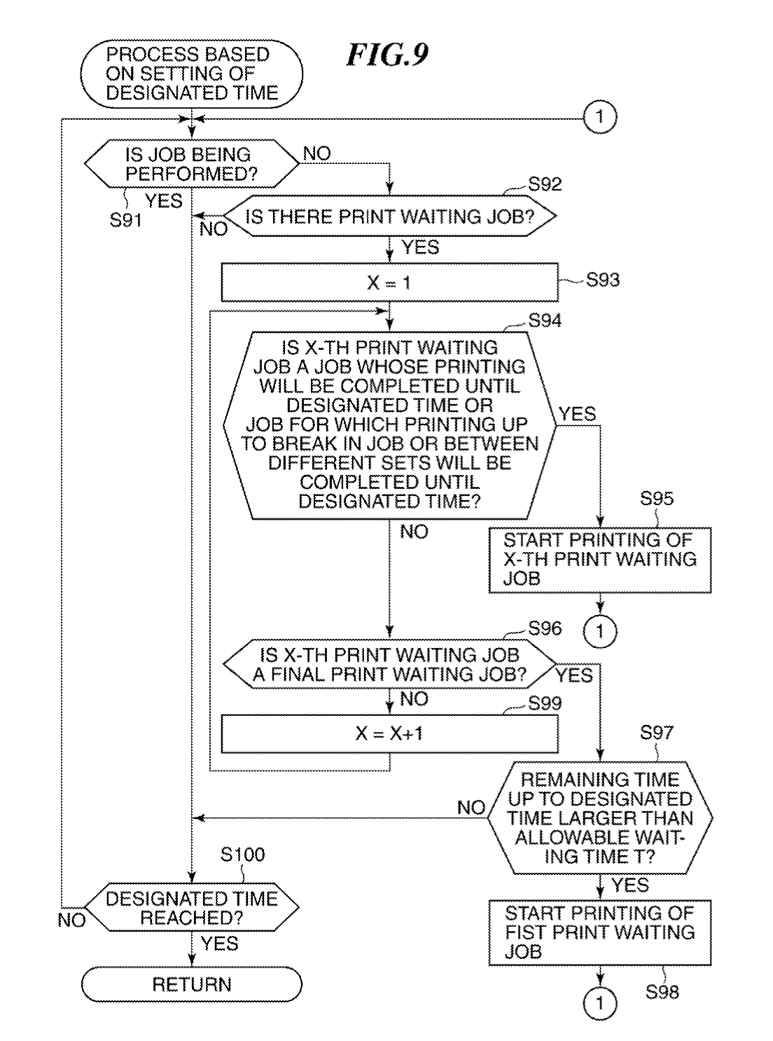

In the following, with reference to FIGS. 5 and 9, a description will be given of a stacking tray descending process executed in a case where the option “to give priority to designated time” and the option “to consider break as much as possible” are selected and the allowable waiting time T is set by the operator on the preference setting screen for reservation of descent of tray.

FIG. 9 shows in flowchart a part of procedures of the stacking tray descending process performed when the just-mentioned preference settings of reservation of descent of tray have been made. It should be noted that the process of FIG. 9 is obtained by expanding the processing performed in step S55 of FIG. 5. The process of FIG. 9 is executed following the processing in steps S51 to S54 of FIG. 5, and the processing in steps S56 to S60 of FIG. 5 is executed following the process of FIG. 9.

In the stacking tray descending process, the control unit 25 accepts a setting of the tray descent time (in step S51 of FIG. 5). If determined in step S52 that there is a job scheduled for being printed at the tray descent time, the control unit 25 calculates a scheduled job completion time and causes the notification screen 62 to display the scheduled job completion time (step S53). If the OK button is pressed on the screen 62 (YES to step S54) or if there is no job scheduled for being printed at the tray descent time (NO to step S52), the process proceeds to step S91 in FIG. 9.

In step S91, the control unit 25 determines whether or not a job is being performed. If determined that a job is being performed (YES to step S91), the control unit 25 determines whether or not the designated time (tray descent time) is reached (step S100). If the designated time is reached (YES to step S100), the process proceeds to step S56 in FIG. 5. On the other hand, if the designated time is not reached, the process returns to step S91.

If determined that a job is not being performed (NO to step S91), the control unit 25 determines whether or not there is a print waiting job that has been received (step S92). If the answer to step S92 is NO, the process proceeds to step S100.

If determined that there is a print waiting job (YES to step S92), the control unit 25 sets an index X, which represents a number counted from the head of a list of print waiting jobs, to a value of 1 (step S93), and determines whether or not the X-th print waiting job is a job whose printing will be completed until the designated time or a job for which printing up to a break in the job or between different sets of printed products will be completed until the designated time (step S94).

If the answer to step S94 is NO, the control unit 25 determines whether or not the X-th print waiting job is a final print waiting job (step S96). If the X-th print waiting job is not a final print waiting job (NO to step S96), the control unit 25 increments the index X by one, and returns to step S94.

On the other hand, if the answer to step S94 is YES, the control unit 25 controls to start printing of the X-th print waiting job (step S95), and returns to step S91.

If determined that the X-th print waiting job is a final print waiting job (YES to step S96), the control unit 25 determines whether or not the remaining time up to the designated time is larger the allowable waiting time T (step S97). If the answer to step S97 is YES, the control unit 25 controls to start printing of a first print waiting job among the print waiting jobs (step S98), and returns to step S91.

On the other hand, if determined that the remaining time up to the designated time is equal to or less than the allowable waiting time T (NO to step S97), the process proceeds to step S100. In other words, the control unit 25 waits for arrival of the designated time without performing printing of the print waiting job, whereby it becomes possible to avoid printing once started from being interrupted. If a print waiting job is not printed when the remaining time up to the designated time is equal to or less than the allowable waiting time T, there is a possibility that productivity is lowered. However, the allowable waiting time T can arbitrarily be set by the operator, and therefore no substantial problem is caused.

With this embodiment, when the designated time is reached, the stacking tray is controlled to be moved downward to the removal position in preference to continuing a job which is in execution. It is therefore possible to effectively proceed printing up to the designated time, while reducing downtime such as waiting stop of the job or waiting descent of the stacking tray, whereby productivity can be improved.

It should be noted that in the above-described embodiment, various control processing is executed by the control unit 25 of the printing apparatus. Alternatively, the control processing can be executed by a control unit (not shown) of the sheet processing apparatus. Although the sheet processing apparatus 40 of the above-described embodiment is constituted by a stacker, a sheet processing apparatus such as a finisher other than the stacker can be used.

### Other Embodiments

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2012-127007, filed Jun. 4, 2012, which is hereby incorporated by reference herein in its entirety.

What is claimed is:

1. A printing apparatus for discharging printed products to a stacking tray which is movably provided in a sheet processing apparatus and on which the printed products can be stacked, comprising:
an acceptance unit configured to accept a setting of a removal time representing time at which printed products are to be taken out of the stacking tray; and
a control unit configured to control, based on the setting of the removal time, to move the stacking tray to a removal position.

2. The printing apparatus according to claim 1, wherein when the removal time is reached, said control unit controls to move the stacking tray to the removal position.

3. The printing apparatus according to claim 1, further including:
a determination unit configured to determine whether or not a print job to discharge printed products to the stacking tray is being performed when the removal time is reached.

4. The printing apparatus according to claim 3, wherein in a case where said determination unit determines that a print job is being performed when the removal time is reached, said control unit controls to stop the print job that is being performed and controls to move the stacking tray to the removal position.

5. The printing apparatus according to claim 3, wherein in a case where said determination unit determines that a print job is being performed when the removal time is reached, said control unit controls to stop the print job that is being performed.

6. The printing apparatus according to claim 3, wherein in a case where said determination unit determines that a print job is being performed when the removal time is reached, said control unit controls to move the stacking tray to the removal position after the print job that is being performed is completed.

7. The printing apparatus according to claim 3, wherein in a case where said determination unit determines that a print job is being performed when the removal time is reached, said control unit waits a break in the print job that is being performed, and then controls to stop the print job and to move the stacking tray to the removal position.

8. The printing apparatus according to claim 7, wherein in a case where plural sets of printed products are output in the print job, the break in the print job that is being performed corresponds to completion of printing up to a break between different sets of printed products.

9. The printing apparatus according to claim 3, wherein said acceptance unit accepts a setting of allowable waiting time, and
in a case where said determination unit determines that a print job is being performed when the removal time is reached, said control unit controls to stop the print job and to move the stacking tray to the removal position, if a break in the print job will not be arrived within the allowable waiting time, but waits a break in the print job and then controls to stop the print job and to move the stacking tray to the removal position, if the break in the print job will be arrived within the allowable waiting time.

10. The printing apparatus according to claim 3, further including:
a notification unit configured, in a case where said determination unit determines that a print job is being performed when the removal time is reached, to notify that there is a print job that is being printed.

11. The printing apparatus according to claim 10, wherein said notification unit notifies a scheduled time of completion of the print job that is being printed.

12. The printing apparatus according to claim 1, wherein the stacking tray is configured to be movable upward and downward inside the sheet processing apparatus according to stack of printed products, and
the stacking tray is configured to be capable of being transported in a state stacked with printed products from the removal position to outside of the sheet processing apparatus.

13. A control method for a printing apparatus for discharging printed products to a stacking tray which is movably provided in a sheet processing apparatus and on which printed products can be stacked, comprising:
an acceptance step of accepting a setting of a removal time representing time at which printed products are to be taken out of the stacking tray; and
a control step of controlling, based on the setting of the removal time, to move the stacking tray to a removal position.

14. A non-transitory computer-readable storage medium storing a program for causing a computer to execute the control method as set forth in claim 13.

15. A printing system comprising:
the printing apparatus as set forth in claim 1; and
a sheet processing apparatus having a stacking tray on which printed products can be stacked, wherein the stacking tray is provided to be movable inside the sheet processing apparatus.
